(19) United States
(12) Patent Application Publication
(10) Pub. No.: US 2011/0061197 A1
(43) Pub. Date: Mar. 17, 2011

(54) HINGE DEVICE AND ELECTRONIC INSTRUMENT USING THE HINGE DEVICE

(75) Inventor: Ryo Shimomura, Toshima-ku (JP)

(73) Assignee: Kabushiki Kaisha Strawberry Corporation, Tokyo (JP)

(21) Appl. No.: 12/561,065

(22) Filed: Sep. 16, 2009

(51) Int. Cl. E05D 7/06; E05F 1/12

(52) U.S. Cl. 16/303; 16/363

(57) ABSTRACT

An object of the present invention is to provide a novel hinge device having extremely high product value, and to provide an electronic device that utilizes this hinge device. The hinge device for rotatably linking a first member (1) and a second member (2) has a first pivoting mount (4) provided to the first member (1), and a second pivoting mount (6) provided to the second member (2) and linked with the first pivoting mount (4) so that relative rotation is possible via a shaft part (5). A stop piece (9) for pressing against and locking onto a protrusion (8) provided to one of the first pivoting mount (4) and the second pivoting mount (6) is provided to the other pivoting mount to block over-rotation at a designated relative rotational position between the first pivoting mount (4) and the second pivoting mount (6).

### BACKGROUND OF THE INVENTION

1. Field of the Invention

The present invention relates to a hinge device and an electronic device that uses this hinge device.

2. Description of the Related Art

In a mobile phone which is a typical example of a portable electronic device (e.g., Japanese Laid-open Patent Publication No. 2005-252492), a foldable device is offered that has a phone main body which can fold up (foldable devices are desirable because they prevent erroneous key operation, increase compactness, and allow a wide range of designs).

Folding devices generally have a structure in which a main body that is used as a first member and has buttons disposed thereupon is linked, in an openable manner, to a superimposed part that is used as a second member and is provided with a display, which is superimposed on this main body. The main body and the superimposed part are pivotably attached so that they can rotate to open and close via a hinge device.

With this hinge device, the second member has second pivoting mount that is superimposed and linked so as to allow relative rotation via a shaft part to a first pivoting mount provided to the first member, and the hinge device thus has a pivoting-attachment structure that allows the superimposed part to rotate open to a designated angle from a superimposed closed condition. For example, a well-known urging mechanism using a cam is provided between the first pivoting mount and the second pivoting mount, and the superimposed part is urged in the closed direction in a range of rotation of the superimposed part with respect to the main body that extends from the closed condition to a designated opening position at which a designated amount of rotation has occurred in the Opening direction. On the other hand, the superimposed part is urged in the opening direction in a range of rotation extending from the maximum open position of the superimposed part (about)160° to a designated rotational position in the closed direction.

Folding devices that are currently in wide circulation as mobile phones, for purposes of convenience, have a stopper (over-rotation blocking part) that is provided to the pivoting link between the main body and the superimposed part that stops rotation at an angle of about 160° when the superimposed part is opened relative to the main body (for many users, talking feels difficult with structures in which the superimposed part opens to 180° C. with respect to the main body, because it is not possible for the phone main body to be close to both the ear and mouth). As shown in FIGS. 2 and 3, when a force P is erroneously applied in the direction of additional rotation (in the industry, this is referred to as a forward force-down condition or reverse-curving condition), the force is applied to the pivoting link between the main body and the superimposed part in the opening direction, and there are cases where the stopper (resin part) on the pivoting link breaks.

### SUMMARY OF THE INVENTION

The applicant of the invention, as a result of continued research and development in consideration of this state of affairs, has developed a novel hinge device that has high product value, and an electronic device that employs this hinge device.

A summary of the present invention is presented below in reference to the figures.

According to a first aspect, there is provided a hinge device for rotatably linking a first member 1 and a second member 2, the hinge device comprising a first pivoting mount 4 provided to the first member 1, and a second pivoting mount 6 provided to the second member 2 and linked with the first pivoting mount 4 so that relative rotation is possible via a shaft part 5 to produce a structure such that a stop piece 9 for pressing against and locking onto a protrusion 8 provided to one of the first pivoting mount 4 and the second pivoting mount 6 is provided to the other pivoting mount to block over-rotation at a designated relative rotational position between the first pivoting mount 4 and the second pivoting mount 6; and at least one of the first pivoting mount 4 and the second pivoting mount 6 is provided so as to be able to slide or incline with respect to the shaft part 5 in a manner such that one mount moves away from the other, and the protrusion 8 and the stop piece 9 are shaped so that when rotational force is applied in the over-rotation direction after the over-rotation has been blocked by the protrusion 8 pressing against and locking onto the stop piece 9, at least one of the first pivoting mount 4 and the second pivoting mount 6 moves in a direction away from the other, the protrusion 8 is carried over and disengaged from, or is carried past and disengaged from, the stop piece 9 in conjunction with the movement, and the over-rotation blocking condition between the first pivoting mount 4 and the second pivoting mount 6 is released.

According to a second aspect, there is provided a hinge device according to the first aspect, wherein the protrusion 8 and the stop piece 9 are shaped so that when rotational force is applied in the over-rotation direction after the over-rotation has been blocked by the protrusion 8 pressing against and locking onto the stop piece 9, at least one of the first pivoting mount 4 and the second pivoting mount 6 moves in a direction away from the other, and the protrusion 8 is carried over and released from, or is carried past and released from, the stop piece 9 in a direction in which the two pivoting mounts separate from each other in conjunction with the movement, rather than a direction in which the mounts rotate relative to each other.

According to a third aspect, there is provided a hinge device according to a first or second aspect, wherein the pressure contact surface 8a of the protrusion 8 for pressing against and locking onto the stop piece 9 is set as a curved surface or inclined surface to produce a structure such that when rotational force is applied in the over-rotation direction after the over-rotation has been blocked by the protrusion 8 pressing against and locking onto the stop piece 9, at least one of the first pivoting mount 4 and the second pivoting mount 6 moves in a direction away from the other, and the protrusion 8 is carried over and released from, or is carried past and released from, the stop piece 9 in conjunction with the movement.

According to a fourth aspect, there is provided a hinge device according to a first aspect, wherein an urging element 10 that presses and urges the first pivoting mount 4 and the second pivoting mount 6 is provided to the shaft part 5, and when rotational force is applied in the over-rotation direction after the over-rotation has been blocked by the protrusion 8 pressing against and locking onto the stop piece 9, at least one of the first pivoting mount 4 and the second pivoting mount 6 moves in a direction away from the other against the pressure of the urging element 10, and the protrusion 8 is carried over and released from, or is carried past and released from, the stop piece 9 in conjunction with the movement.

According to a fifth aspect, there is provided a hinge device according to a second aspect wherein an urging element 10 that presses and urges the first pivoting mount 4 and the second pivoting mount 6 is provided to the shaft part 5, and when rotational force is applied in the over-rotation direction after the over-rotation has been blocked by the protrusion 8 pressing against and locking onto the stop piece 9, at least one of the first pivoting mount 4 and the second pivoting mount 6 moves in a direction away from the other against the pressure of the urging element 10, and the protrusion 8 is carried over and released from, or is carried past and released from, the stop piece 9 in conjunction with the movement.

According to a sixth aspect, there is provided a hinge device according to a third aspect, wherein an urging element 10 that presses and urges the first pivoting mount 4 and the second pivoting mount 6 is provided to the shaft part 5, and when rotational force is applied in the over-rotation direction after the over-rotation has been blocked by the protrusion 8 pressing against and locking onto the stop piece 9, at least one of the first pivoting mount 4 and the second pivoting mount 6 moves in a direction away from the other against the pressure of the urging element 10, and the protrusion 8 is carried over and released from, or is carried past and released from, the stop piece 9 in conjunction with the movement.

According to a seventh aspect, there is provided a hinge device according to a first aspect, wherein the first pivoting mount 4 is provided to a distal end of a first protruding plate 11 provided in a protruding state to the first member 1, the second pivoting mount 6 that is linked with the first pivoting mount 4 so as to be able to undergo relative rotation via the shaft part 5 is provided to a distal end of a second protruding plate 12 provided in a protruding state to the second member 2, and a section disposed towards the base end of at least one of the first protruding plate 11 and second protruding plate 12 is provided so as to be curved or arced, and is provided so that at least one of the first pivoting mount 4 and the second pivoting mount 6 moves away from the other.

According to an eighth aspect, there is provided a hinge device according to a second aspect, wherein the first pivoting mount 4 is provided to a distal end of a first protruding plate 11 provided in a protruding state to the first member 1, the second pivoting mount 6 that is linked with the first pivoting mount 4 so as to be able to undergo relative rotation via the shaft part 5 is provided to a distal end of a second protruding plate 12 provided in a protruding state to the second member 2, and a section disposed towards the base end of at least one of the first protruding plate 11 and the second protruding plate 12 is provided so as to be curved or arced, and is provided so that at least one of the first pivoting mount 4 and the second pivoting mount 6 moves away from the other.

According to a ninth aspect, there is provided a hinge device according to a third aspect, wherein the first pivoting mount 4 is provided to a distal end of a first protruding plate 11 provided in a protruding state to the first member 1, the second pivoting mount 6 that is linked with the first pivoting mount 4 so as to be able to undergo relative rotation via the shaft part 5 is provided to a distal end of a second protruding plate 12 provided in a protruding state to the second member 2, and a section disposed towards the base end of at least one of the first protruding plate 11 and the second protruding plate 12 is provided so as to be curved or arced, and is provided so that at least one of the first pivoting mount 4 and the second pivoting mount 6 moves away from the other.

According to a tenth aspect, there is provided a hinge device according to a fourth aspect, wherein the first pivoting mount 4 is provided to a distal end of a first protruding plate 11 provided in a protruding state to the first member 1, the second pivoting mount 6 that is linked with the first pivoting mount 4 so as to be able to undergo relative rotation via the shaft part 5 is provided to a distal end of a second protruding plate 12 provided in a protruding state to the second member 2, and a section disposed towards the base end of at least one of the first protruding plate 11 and the second protruding plate 12 is provided so as to be curved or arced, and is provided so that at least one of the first pivoting mount 4 and the second pivoting mount 6 moves away from the other.

According to an eleventh aspect, there is provided a hinge device according to a fifth aspect, wherein the first pivoting mount 4 is provided to a distal end of a first protruding plate 11 provided in a protruding state to the first member 1, the second pivoting mount 6 that is linked with the first pivoting mount 4 so as to be able to undergo relative rotation via the shaft part 5 is provided to a distal end of a second protruding plate 12 provided in a protruding state to the second member 2, and a section disposed towards the base end of at least one of the first protruding plate 11 and the second protruding plate 12 is provided so as to be curved or arced, and is provided so that at least one of the first pivoting mount 4 and the second pivoting mount 6 moves away from the other.

According to a twelfth aspect, there is provided a hinge device according to a sixth aspect, wherein the first pivoting mount 4 is provided to a distal end of a first protruding plate 11 provided in a protruding state to the first member 1, the second pivoting mount 6 that is linked with the first pivoting mount 4 so as to be able to undergo relative rotation via the shaft part 5 is provided to a distal end of a second protruding plate 12 provided in a protruding state to the second member 2, and a section disposed towards the base end of at least one of the first protruding plate 11 and the second protruding plate 12 is provided so as to be curved or arced, and is provided so that at least one of the first pivoting mount 4 and the second pivoting mount 6 moves away from the other.

According to a thirteenth aspect, there is provided a hinge device according to a first aspect, wherein a cam part 13 that rotates together with the second pivoting mount 6.or the first pivoting mount 4, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a fourteenth aspect, there is provided a hinge device according to a second aspect, wherein a cam part 13 that rotates together with the second pivoting mount 6 or the first pivoting mount 6, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a fifteenth aspect, there is provided a hinge device according to a third aspect, wherein a cam part 13 that rotates together with the second pivoting mount 6 or the first pivoting mount 6, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a sixteenth aspect, there is provided a hinge device according to a fourth aspect, wherein a cam part 13 that rotates together with the second pivoting mount 6 or the first pivoting mount 6, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a seventeenth aspect, there is provided a hinge device according to a fifth aspect, wherein a cam part 13 that rotates together with the second pivoting mount 6 or the first pivoting mount 6, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to an eighteenth aspect, there is provided a hinge device according to a sixth aspect, wherein a cam part 13 that rotates together with the second pivoting mount 6 or the first pivoting mount 4, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a nineteenth aspect, there is provided a hinge device according to a seventh aspect, wherein a cam part 13 that rotates together with the second pivoting mount 6 or the first pivoting mount 4, and a cam engaging part 14 that rotates together with the first pivoting mount 4 or the second pivoting mount 6 are provided while allowed to rotate relative to each other about the shaft part 5 to produce a structure, such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a twentieth aspect, there is provided a hinge device according to a eighth aspect, wherein a cam part 13 that rotates together with the second pivoting mount 6 or the first pivoting mount 4, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a twenty-first aspect, there is provided a hinge device according to a ninth aspect, wherein a cam part 13 that rotates together with the second pivoting mount 6 or the first pivoting mount 4, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a twenty-second aspect, there is provided a hinge device according to a tenth aspect, wherein a cam part 13 that rotates together with the second pivoting mount 6 or the first pivoting mount 4, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a twenty-third aspect, there is provided a hinge device according to an eleventh aspect, wherein a cam part 13 that rotates together with the second pivoting mount 6 or the first pivoting mount 4, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a twenty-fourth aspect, there is provided a hinge device according to a twelfth aspect, wherein a cam part 13 that rotates together with the second pivoting mount 6 or the first pivoting mount 4, and a cam engaging part 14 that rotates together with the first pivoting mount 4 or the second pivoting mount 6 are provided while allowed to rotate relative to each other about the shaft part 5 to produce a structure such that when the relatively rotating cam part 13 and cam engaging part 14 come into a concavoconvex engagement or a transient concavoconvex engagement, over-rotation of the first pivoting mount 4 and the second pivoting mount 6 is blocked by pressing and locking of the protrusion 8 and the stop piece 9, whereby the rotational position of the cam part 13 and the cam engaging part 14 is maintained; an engagement urging element 10 for urging at least one of the cam part 13 and the cam engaging part 14 in the engagement direction is provided to produce a structure in which a concavoconvex engagement or a transient concavoconvex engagement of the cam part 13 and the cam engaging part 14 is maintained by the engagement and urging of the engagement urging element 10, and the cam part 13 and the cam engaging part 14 can be released from the concavoconvex engagement and rotated relative to each other against the engagement and urging; and the cam engaging part 14 or the cam part 13 is provided to the surface of the first pivoting mount 4 or the second pivoting mount 6 that is on the opposite side from the surface that faces the second pivoting mount 6 or the first pivoting mount 4.

According to a twenty-fifth aspect, there is provided an electronic device that uses a hinge device wherein a main body having a display part 17 or an operating part 16 on a top surface is used as a first member 1 or a second member 2, a superimposed part having a display part 17 or an operating part 16 on a downward surface thereof is used as the second member 2 or the first member 1, and the ends of the main body and superimposed part are pivoted and linked together by the hinge device according to any of the first through twenty-fourth aspects.

As a result of the structures described above, the present invention reliably blocks over-rotation of the first member and second member. Because a structure is provided whereby this over-rotation blocking condition is released if a strong rotational force is applied in a direction (over-rotation direction) in which the first member and second member are further opened, damage to the parts involved with pivotably mounting the first member and second member can be prevented in response to this condition, in contrast to the conventional example described above. A novel hinge device having extremely high product value is thus provided.

In addition, the invention according to the second and third aspects is a novel hinge device having extremely high product value whereby the protrusion is favorably disengaged with respect to the stop piece, and this function can be reliably manifested.

In addition, with the invention according to the fourth through sixth aspects, the mechanism whereby over-rotation is released does not depend solely on the shapes of the protrusion and the locking part. By providing an urging element that resists movement of the first pivoting mount and the second pivoting mount in the separation direction, the timing whereby the over-rotation blocking condition between the first pivoting mount and the second pivoting mount is released can be simply and reliably provided by suitably altering the urging force of the urging element. Also provided is a novel hinge device having extremely high product value in which rattling between the first pivoting mount and the second pivoting mount can be prevented from occurring in a structure in which at least one of the first pivoting mount and the second pivoting mount moves in a direction away from the other.

Moreover, with the invention according to the seventh through eleventh aspects, it is possible to provide a novel hinge device having extremely high product value, such as being able to easily and reliably produce a structure in which at least one of the first pivoting mount and the second pivoting mount can slide or incline relative to a shaft part so as to move away from the other.

In addition, with the invention according to the twelfth through twenty-fourth aspects, it is possible to provide a novel hinge device having extremely high product value, such as being able to produce a highly efficient structure obtained by integrating a cam structure for engaging and maintaining the rotational position between the first member and the second member, a structure for blocking the over-rotation of the first member and the second member, and a structure for releasing the over-rotation blocking condition.

In addition, with the invention according to the twenty-fifth aspect, it is possible to provide an electronic device using a novel hinge device that is extremely practical and has the above actions and effects.

### BRIEF DESCRIPTION OF THE DRAWINGS

FIG. 1 is view showing the manner in which the present embodiment is used;

FIG. 2 is a view showing the manner in which the present embodiment operates;

FIG. 3 is a view showing the manner in which the present embodiment operates;

FIG. 4 is a perspective view showing the essential parts of the embodiment;

FIG. 5 is an exploded perspective view showing the essential parts of the embodiment;

FIG. 6 is an exploded perspective view showing the essential parts of the embodiment;

FIG. 7 is an explanatory view of the operation of the essential parts of the embodiment;

FIG. 8 is an explanatory sectional view of the essential parts of the embodiment;

FIG. 9 is an explanatory view of the operation of the essential parts of the embodiment;

FIG. 10 is an explanatory sectional view of the essential parts of the embodiment;

FIG. 11 is an explanatory view of the operation of the essential parts of the embodiment; and

FIG. 12 is an explanatory view of the operation of the essential parts of the embodiment.

### DESCRIPTION OF THE PREFERRED EMBODIMENTS

A preferred embodiment of the present invention is described briefly below in reference to the drawings.

The first member 1 and the second member 2 are rotated by rotating a first pivoting mount 4 provided to a first member 1, and a second pivoting mount 6 provided to a second member 2 relative to each other via a shaft part 5.

When the first pivoting mount 4 and the second pivoting mount 6 are rotated relative to each other, a protrusion 8 that is provided to either the first pivoting mount 4 or the second pivoting mount 6 presses against and locks onto a stop piece 9 provided to the other pivoting mount at a designated relative rotational position of the first pivoting mount 4 and the second pivoting mount 6, thereby blocking over-rotation.

Consequently, in cases in which the hinge device of the present invention is utilized in a folding mobile phone, for example, in which the first member 1 is the main body, and the second member 2 is the superimposed part, opening the superimposed part relative to the main body blocks over-rotation as a result of locking of the protrusion 8 on the stop piece 9, thereby maintaining the rotational position of the superimposed part in a designated opened rotational position relative to the main body (over-rotation is blocked).

However, with the present invention, at least one of the first pivoting mount 4 and the second pivoting mount 6 is provided so as to be able to slide or incline with respect to the shaft part 5 in a manner such that one mount moves away from the other, and the protrusion 8 and the stop piece 9 are shaped so that when rotational force is applied in the over-rotation direction after the over-rotation has been blocked by the protrusion 8 pressing against and locking onto the stop piece 9, at least one of the first pivoting mount 4 and the second pivoting mount 6 moves in a direction away from the other, the protrusion 8 is carried over and disengaged from, or is carried past and disengaged from, the stop piece 9 in conjunction with the movement, and the over-rotation blocking condition between the first pivoting mount 4 and the second pivoting mount 6 is released.

Consequently, when a strong rotational force is applied to the main body in the attempt to release the superimposed part in an over-rotation blocking condition in which the superimposed part is at the designated open rotational position with respect to the main body described above, the superimposed part is additionally opened and rotated with respect to the main body in response to the force. The structure whereby this is achieved is a structure that is compliant and allows release of the over-rotation blocking condition, rather than a condition in which, for example, enhanced strength is provided to areas designed to block over-rotation, or other excessive measures are taken to counter a strong rotational force. Consequently, there is no damage to the various parts used for blocking this over-rotation.

### Examples

Specific examples of the present invention are described below in reference to the drawings.

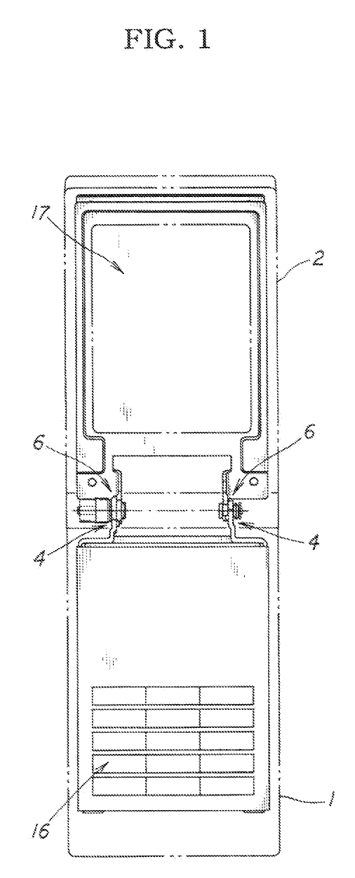

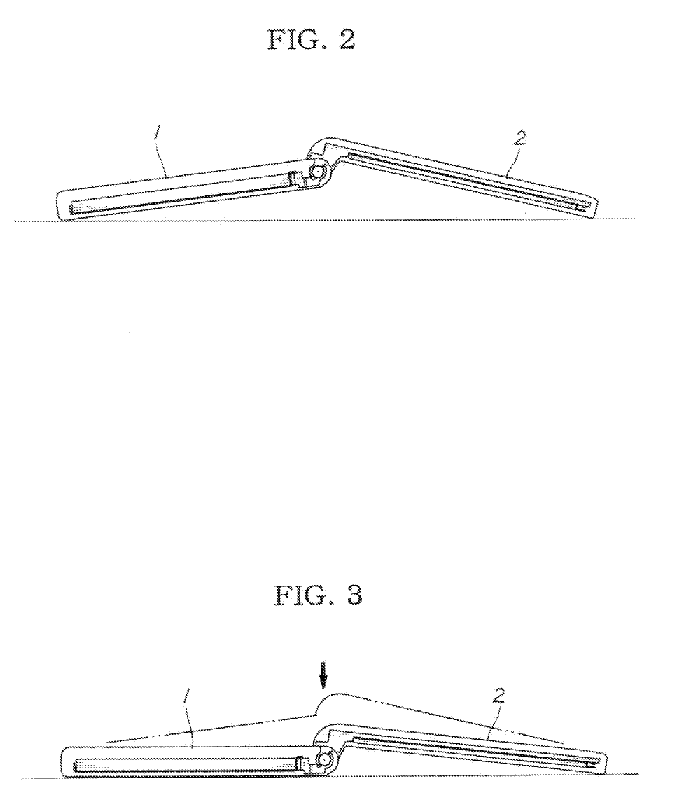

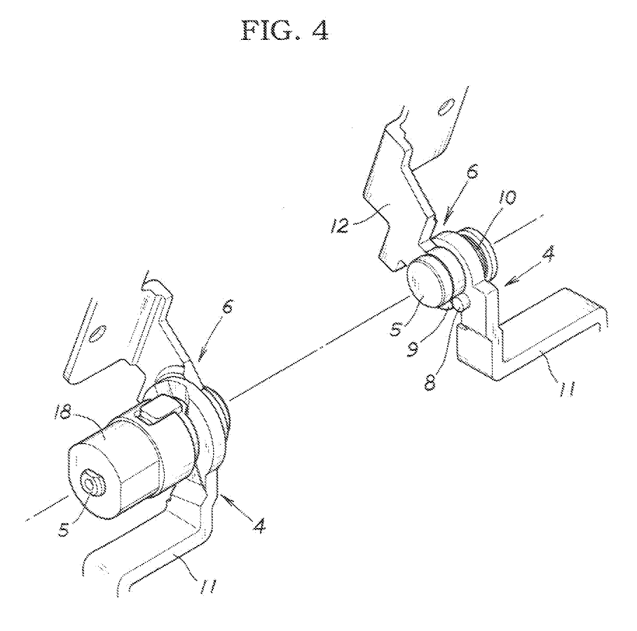

In this example, as shown in FIG. 1, which shows a device for use in a clamshell mobile phone, a main body having a key operating part 16 is used as the first member 1, and an opening lid part (superimposed part) having a display part 17 (LCD) is used as the second member 2. The hinge device of the present invention is utilized in a pivoting attachment structure whereby an opened condition (use position) is produced by lifting up the second member 2 from the closed position in which the first member 1 and the second member 2 are superimposed.

In this example, a linkage part (linkage fastener) shaped as a plate is provided so as to protrude at locations to the left and right of the base end of the first member (main body 1), and the distal ends of the first protruding plate 11 that protrude to the left and right are provided to an opposing condition to the left and right as the first pivoting mount 4 shaped as a plate. On the other hand, a linkage part (linkage fastener) shaped as a plate is provided so as to protrude at the left and right positions of the base end of the second member (superimposed part 2), and the distal ends of the second protruding plate 12 that protrude on the left and right thereof are provided to an opposing condition to the left and right as the second pivoting mount 6 shaped as a plate. Each of the left and right first pivoting mounts 4 is superimposed on the respective inner surfaces of the left and right second pivoting mounts 6. Each of the left and right second pivoting mounts 6 may be disposed so as to superimpose on the insides of the left and right first pivoting mounts 4, or one of the left or right second pivoting mounts 6 may be disposed to the inside of either the left and right first pivoting mounts 4, and the other of the second pivoting mounts 6 may be disposed to the outside of the other of the first pivoting mounts 4.

The linkage between one of the first pivoting mounts 4 and the second pivoting mounts 6 (left side in FIG. 1) will first be described. For the below-described linkage between the other of the first pivoting mounts 4 and the second pivoting mounts 6 (right side in FIG. 1), it is also possible to use a linkage mechanism having a cam mechanism in which the below-described engagement and urging between a cam part and cam engaging part is used to obtain a rotatable urging force.

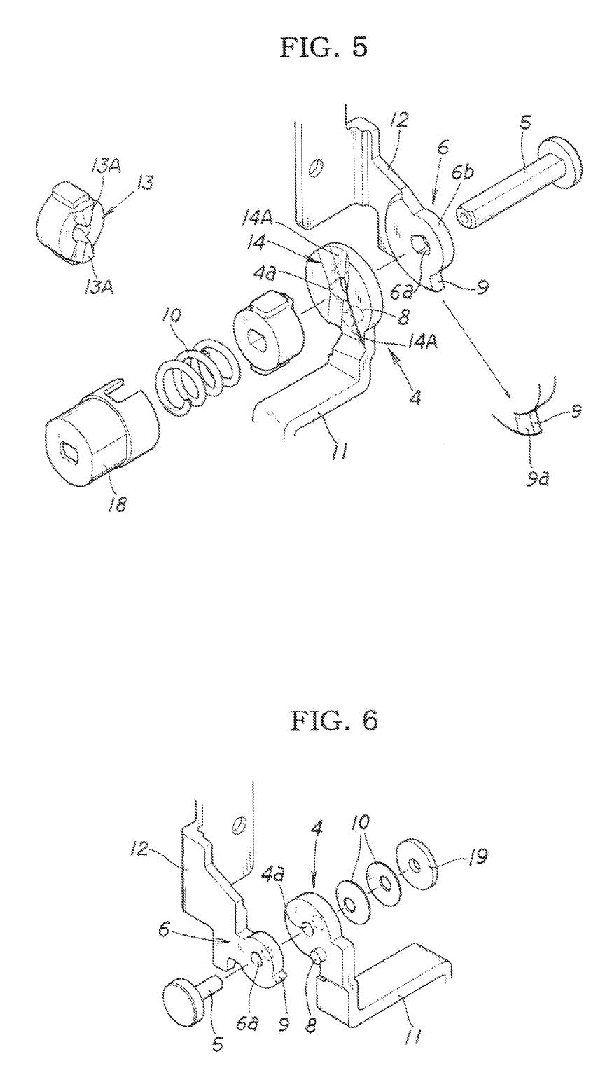

Specifically, as shown in FIG. 5, a shaft part 5 is slidably inserted in a nonrotatable state into a fastening hole 6a provided to the second pivoting mount 6. The shaft part 5 in the second pivoting mount 6 is slidably inserted in a rotatable state into a bearing hole 4a provided to the first pivoting mount 4, and the second pivoting mount 6 and the first pivoting mount 4 are thus linked in a superimposed state while allowed to rotate with respect to each other via this shaft part 5. A spacer or the like may be provided between the first pivoting mount 4 and the second pivoting mount 6.

In addition, a cam part 13 is slidably provided in a nonrotatable state to the shaft part 5 nonrotatably fixed to the second pivoting mount 6. A cam engaging part 14 for engaging the cam part 13 by mating of a recess and protrusion is provided to the first pivoting mount 4.

Specifically, a cam part 13 having a pair of convexities 13A that rotate together with the shaft part 5 is provided to the second pivoting mount 6 in this example.

A pair of concavities 14A is formed on the surface that is on the other side from the surface that is opposite to (superimposes on) the second pivoting mount 6 on one surface of the first pivoting mount 4, and this first pivoting mount 4 itself is the cam engaging part 14.

More specifically, the cam part 13 capable of sliding along the shaft part 5 nonrotatably fitted into the second pivoting mount 6 as described above is provided to the shaft part 5.

In addition, a spring 10 used as an urging element is provided to a casing 18 that is irremovably linked by crimping in a state in which the distal end of the shaft part 5 is inserted in a nonrotatable state to produce a structure in which the spring 10 causes the cam part 13 slidably disposed in the casing 18, and the cam engaging part 14 provided to the first pivoting mount 4, to engage and urge the shaft part 5 to perform axial rotation in the direction of engagement between the recess and the protrusion (along the shaft part 5).

Consequently, when the superimposed part 2 rotates with respect to the main body 1, the second pivoting mount 6 (cam part 13) provided to the superimposed part 2 rotates with respect to the first pivoting mount 4 (cam engaging part 14) provided to the main body 1.

Specifically, the shaft part 5 rotates with respect to the cam engaging part 14 of the first pivoting mount 4, and the cam part 13 (second pivoting mount 6) nonrotatably provided to the shaft part 5 rotates with respect to the cam engaging part 14, whereby the cam part 13 and the cam engaging part 14 are rotated relative to each other while pressed and urged by an urging element (spring 10) about the shaft part 5 when the superimposed part 2 rotates relative to the main body 1 and assumes a superimposed state. The convexities 13A of the cam part 13 thus become engaged with the concavities 14A of the cam engaging part 14 by fitting together during rotation.

In other words, the two parts of the phone are urged to rotate (to close) in the superposition direction by the pushing of the urging element (spring 10) and the cam engagement brought about by the concavoconvex mating force. Engagement of the superimposed state is thus preserved by the concavoconvex engagement urged by the urging element (spring 10).

Moreover, when the two parts of the phone are rotated with mild force to about 160° in the opening direction in this example, the open rotational position is again brought into a transient concavoconvex engagement, and the two parts of the phone are urged to rotate (to open) in the opening direction. In this example, the transient concavoconvex engagement of the cam part 13 and the cam engaging part 14 is achieved by the fact that the protrusion 8 provided between the first pivoting mount 4 and the second pivoting mount 6 described below presses against and locks onto the stop piece 9, and over-rotation is blocked when the superimposed part 2 is at a designated open rotational position with respect to the main body 1.

Consequently, by setting the rotational friction between the cam part 13 and the cam engaging part 14 due to the urging force of the urging element (spring 10) to an appropriate level, smooth rotation is produced and a free stop is achieved whereby the rotational position is preserved by the friction at the position at which the hand is removed. The timing of the engagement and retention at the designated open rotational position can be adjusted as desired by setting the free stop at any opening angle.

In addition, the friction needed to achieve the free stop can be adjusted using the condition of the rotational contact surfaces, the urging force of the urging element (spring 10), or the like.

Furthermore, in this example, the first pivoting mount 4 and the second pivoting mount 6 are superimposed while pressed against each other by the pressure of the urging element (spring 10).

In this example, the shaft part 5 is disposed closer to the superimposed part 2, and the bearing part 4a is disposed closer to the main body 1 to allow the superimposed part 2 to be opened and closed by rotation. However, the reverse may also be the case. In addition, similar to the relationship between the cam part 13 and the cam engaging part 14, the shaping means are not limited to the present examples and can be designed into a variety of structures.

Another linkage between the first pivoting mount 4 and the second pivoting mount 6′ is described below (right side in FIG. 1).

Specifically, as shown in FIG. 6, a shaft part 5 is slidably inserted in a rotatable manner into an attachment hole 6a provided to the second pivoting mount 6, the shaft part 5 that passes through the second pivoting mount 6 is slidably inserted into the first pivoting mount 4 in a rotatable manner, and the shaft part is retained a retaining member 19. A hearing hole 4a in rotatable engagement with the shaft part 5 is provided to the first pivoting mount 4.

Consequently, the first pivoting mount 4 and the second pivoting mount 6 can rotate with respect to each other via the shaft part 5.

In addition, an urging element 10 (plate spring) is fitted on the shaft part 5 between the outer surface of the first pivoting mount 4 and the retaining member 19. The first pivoting mount 4 and the second pivoting mount 6 are superimposed on each other by being pressed together by the pressure of the urging element 10.

An over-rotation blocking mechanism P is provided between each of the left and right first pivoting mounts 4 and the left and right second pivoting mounts 6 having the structure described above.

Specifically, as shown in FIGS. 5 and 6, an over-rotation blocking mechanism P is provided so that a stop piece 9 presses against and locks onto a protrusion 8 provided to either the first pivoting mount 4 or the second pivoting mount 6 (in this example, the first pivoting mount 4), and the stop piece 9 is provided to the other pivoting mount (in this example, the second pivoting mount 6) to stop over-rotation at a designated relative rotational location of the first pivoting mount 4 and the second pivoting mount 6.

In this example, the protrusion 8 is provided to the inner surface of the first pivoting mount 4, and the stop piece 9 that presses against and locks onto this protrusion 8 is provided to the outer circumferential edge part of the second pivoting mount 6 that moves with the protrusion 8 in an attached condition. However, the protrusion 8 may be provided to the second pivoting mount 6, and the stop piece 9 that locks the protrusion 8 may be provided to the first pivoting mount 7.

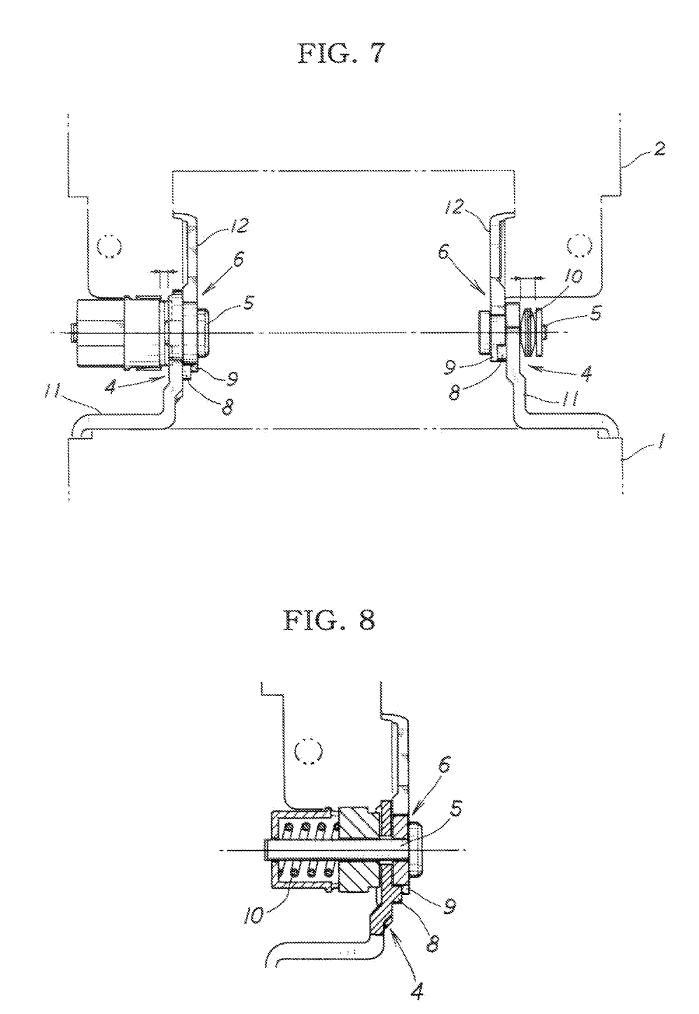

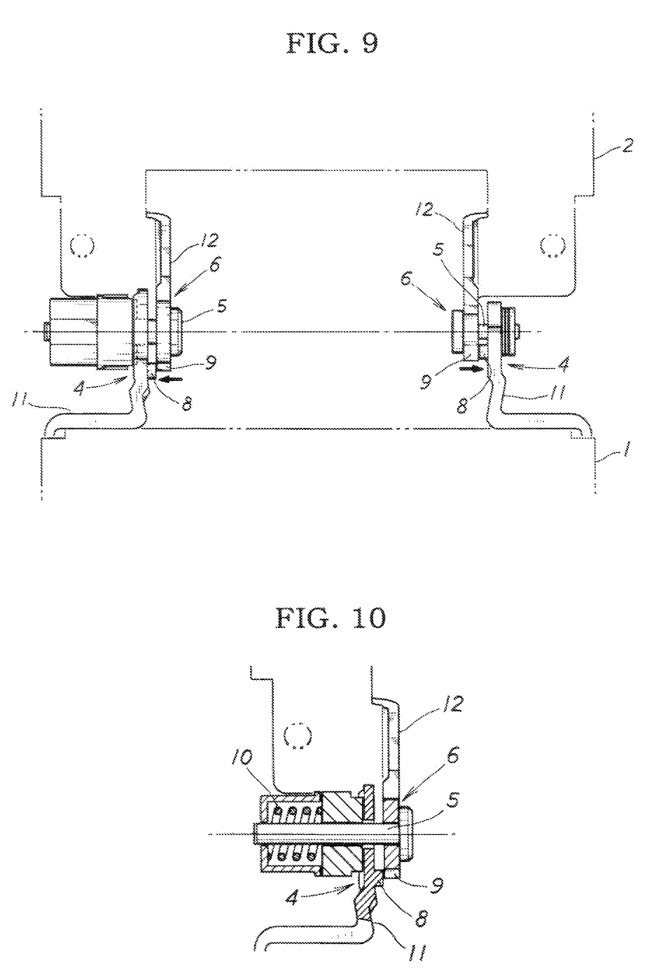

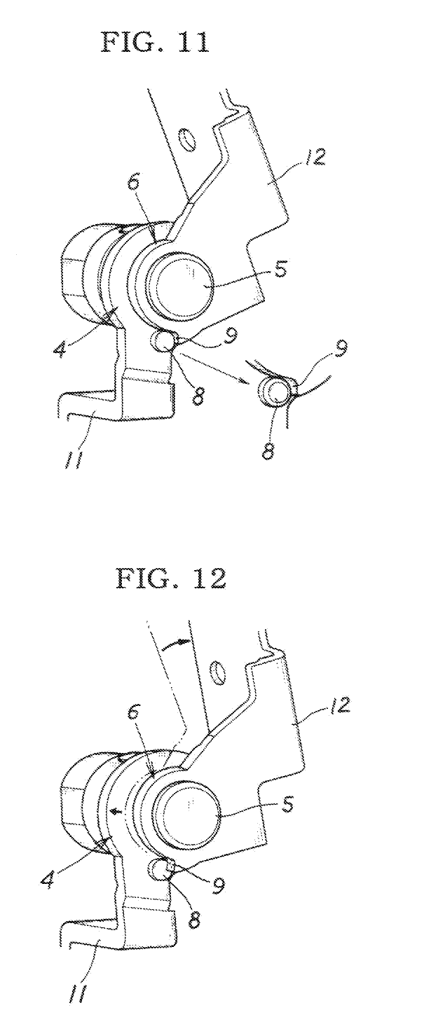

In addition, the over-rotation blocking mechanism P has a structure in which at least one of the first pivoting mount 4 and the second pivoting mount 6 is provided so as to be able to slide or incline with respect to the shaft part 5 in a manner such that one mount moves away from the other, and the protrusion 8 and the stop piece 9 are shaped so that when rotational force (strong rotational force) is applied in the over-rotation direction after the over-rotation has been blocked by the protrusion 8 pressing against and locking onto the stop piece 9, at least one of the first pivoting mount 4 and the second pivoting mount 6 moves in a direction away from the other (as shown in FIG. 7, in this example, the first pivoting mount 4 moves away from the second pivoting mount 6 by sliding along the shaft part 5), and, along therewith, the protrusion 8 is carried over and disengaged from the stop piece 9, thereby allowing release of the over-rotation blocking condition of the first pivoting mount 4 and the second pivoting mount 6.

In additional detail, the protrusion 8 and the stop piece 9 are shaped so that the first pivoting mount 4 and the second pivoting mount 6 are brought into contact with each other and superimposed by the pressure of the urging element 10, at least one of the first pivoting mount 4 and the second pivoting mount 6 moves away from the other mount against the pressure of the urging element 10, the protrusion 8 is carried over and disengaged from the stop piece 9 in a direction in which the pivoting mounts 4 and 6 separate from each other, rather than a direction in which the mounts rotate relative to each other, and a structure is produced whereby the over-rotation blocking condition between the first pivoting mount 4 and the second pivoting mount 6 is released, as described above.

Specifically, the protrusion 8 on the inner surface of the first pivoting mount 4 is configured by providing a cylindrical body that has a curved circumferential surface, whereas the stop piece 9 onto which this protrusion 8 locks is configured by providing an erect part on the end of the rubbing surface 6b. The rubbing surface has an arc shape when viewed from the front, and is formed on the outer edge of the second pivoting mount 6. The protrusion 8 and the stop piece 9 come into contact with each other along the curved surface to produce an over-rotation blocking condition in which the protrusion 8 is locked onto the abutment part 9 so that the condition is released when an additional strong rotational force is applied in the over-rotation direction.

Moreover, as shown in FIG. 5, a tapered surface 9a that is inclined downward in the direction in which the protrusion 8 is released (the direction in which the two pivoting mounts separate) may be suitably formed on the stop piece 9.

A structure is used in this example whereby release readily occurs when strong rotation is provided to the over-rotation direction as a result of the shape of the protrusion 8 and the stop piece 9, but it is possible to suitably adjust the timing of the release by setting the degree of curvature or bend in the first protruding plate 11 and the second protruding plate 12, as well as by setting the pressing force of the urging element.

Because the structure described above is used in this example, the main body 1 and the superimposed part 2 are rotated by rotating the first pivoting mount 4 provided to the main body 1 and the second pivoting mount 6 provided to the superimposed part 2 via the shaft part 5 relative to each other.

Over-rotation is blocked as a result of locking of the protrusion 8 provided to the first pivoting mount 4 when the protrusion presses against the stop piece 9 provided to the second pivoting mount 6 at a designated corresponding rotational position between the first pivoting mount 4 and the second pivoting mount 6 during relative rotation of the first pivoting mount 4 and the second pivoting mount 6 (refer to FIGS. 7 and 8).

In other words, when the superimposed part 2 is opened relative to the main body 1, over-rotation is blocked by the protrusion 8 pressing against and locking onto the stop piece 9, and the rotational position of the superimposed part 2 is maintained in a designated opened rotational position with respect to the main body 1 (over-rotation is blocked).

At this time, the transient concavoconvex engagement of the cam part 13 and the cam engaging part 14 provided between the first pivoting mount 4 and the second pivoting mount 6 is maintained.

In addition, if additional rotational force greater than a designated strength is applied in the over-rotation direction in this example after the protrusion 8 presses against and locks onto the stop piece 9 to block over-rotation, then at least one of the first pivoting mount 4 and the second pivoting mount 6 will move in the separation direction, the protrusion 8 will be carried over and separated from the stop piece 9 in conjunction with the movement, and the over-rotation blocking condition between the first pivoting mount 4 and the second pivoting mount 6 will be released.

Consequently, when a strong rotational force is applied to the main body 1 in the attempt to release the superimposed part 2 in an over-rotation blocking condition in which the superimposed part 2 is at the designated open rotational position with respect to the main body 1 in accordance with the example, the superimposed part is additionally opened and rotated with respect to the main body in response to the force. The structure whereby this is achieved is a structure that is compliant and allows release of the over-rotation blocking condition, rather than a condition in which, for example, enhanced strength is provided to areas designed to block over-rotation, or other excessive measures are taken to counter a strong rotational force. Consequently, there is no damage to the various parts used for blocking this over-rotation.

The present invention is not restricted to this example, and suitable design changes may be made to the specific structures of each of the constituent elements.

1. A hinge device for rotatably linking a first member and a second member, the hinge device comprising a first pivoting mount provided to the first member, and a second pivoting mount provided to the second member and linked with the first pivoting mount so that relative rotation is possible via a shaft part to produce a structure such that a stop piece for pressing against and locking onto a protrusion provided to one of the first pivoting mount and the second pivoting mount is provided to the other pivoting mount to block over-rotation at a designated relative rotational position between the first pivoting mount and the second pivoting mount;
and at least one of the first pivoting mount and the second pivoting mount is provided so as to be able to slide or incline with respect to the shaft part in a manner such that one mount moves away from the other, and the protrusion and the stop piece are shaped so that when rotational force is applied in the over-rotation direction after the over-rotation has been blocked by the protrusion pressing against and locking onto the stop piece, at least one of the first pivoting mount and the second pivoting mount moves in a direction away from the other, the protrusion is carried over and disengaged from, or is carried past and disengaged from, the stop piece in conjunction with the movement, and the over-rotation blocking condition between the first pivoting mount and the second pivoting mount is released.

2. The hinge device according to claim 1, wherein the protrusion and the stop piece are shaped so that when rotational force is applied in the over-rotation direction after the over-rotation has been blocked by the protrusion pressing against and locking onto the stop piece, at least one of the first pivoting mount and the second pivoting mount moves in a direction away from the other, and the protrusion is carried over and disengaged from, or is carried past and disengaged from, the stop piece in a direction in which the two pivoting mounts separate from each other in conjunction with the movement, rather than a direction in which the mounts rotate relative to each other.

3. The hinge device according to claim 1, wherein the pressure contact surface of the protrusion for pressing against and locking onto the stop piece is set as a curved surface or inclined surface to produce a structure such that when rotational force is applied in the over-rotation direction after the over-rotation has been blocked by the protrusion pressing against and locking onto the stop piece, at least one of the first pivoting mount and the second pivoting mount moves in a direction away from the other, and the protrusion is carried over and released from, or is carried past and released from, the stop piece in conjunction with the movement.

4. The hinge device according to claim 1, wherein an urging element that presses and urges the first pivoting mount and the second pivoting mount is provided to the shaft part, and when rotational force is applied in the over-rotation direction after the over-rotation has been blocked by the protrusion pressing against and locking onto the stop piece, at least one of the first pivoting mount and the second pivoting mount moves in a direction away from the other against the pressure of the urging element, and the protrusion is carried over and released from, or is carried past and released from, the stop piece in conjunction with the movement.

5. The hinge device according to claim 2, wherein an urging element that presses and urges the first pivoting mount and the second pivoting mount is provided to the shaft part, and when rotational force is applied in the over-rotation direction after the over-rotation has been blocked by the protrusion pressing against and locking onto the stop piece, at least one of the first pivoting mount and the second pivoting mount moves in a direction away from the other against the pressure of the urging element, and the protrusion is carried over and released from, or is carried past and released from, the stop piece in conjunction with the movement.

6. The hinge device according to claim 3, wherein an urging element that presses and urges the first pivoting mount and the second pivoting mount is provided to the shaft part, and when rotational force is applied in the over-rotation direction after the over-rotation has been blocked by the protrusion pressing against and locking onto the stop piece, at least one of the first pivoting mount and the second pivoting mount moves in a direction away from the other against the pressure of the urging element, and the protrusion is carried over and released from, or is carried past and released from, the stop piece in conjunction with the movement.

7. The hinge device according to claim 1, wherein the first pivoting mount is provided to a distal end of a first protruding plate provided in a protruding state to the first member, the second pivoting mount that is linked with the first pivoting mount so as to be able to undergo relative rotation via the shaft part is provided to a distal end of a second protruding plate provided in a protruding state to the second member, and a section disposed towards the base end of at least one of the first protruding plate and the second protruding plate is provided so as to be curved or arced, and is provided so that at least one of the first pivoting mount and the second pivoting mount moves away from the other.

8. The hinge device according to claim 2, wherein the first pivoting mount is provided to a distal end of a first protruding plate provided in a protruding state to the first member, the second pivoting mount that is linked with the first pivoting mount so as to be able to undergo relative rotation via the shaft part is provided to a distal end of a second protruding plate provided in a protruding state to the second member, and a section disposed towards the base end of at least one of the first protruding plate and the second protruding plate is provided so as to be curved or arced, and is provided so that at least one of the first pivoting mount and the second pivoting mount moves away from the other.

9. The hinge device according to claim 3, wherein the first pivoting mount is provided to a distal end of a first protruding plate provided in a protruding state to the first member, the second pivoting mount that is linked with the first pivoting mount so as to be able to undergo relative rotation via the shaft part is provided to a distal end of a second protruding plate provided in a protruding state to the second member, and a section disposed towards the base end of at least one of the first protruding plate and the second protruding plate is provided so as to be curved or arced, and is provided so that at least one of the first pivoting mount and the second pivoting mount moves away from the other.

10. The hinge device according to claim 4, wherein the first pivoting mount is provided to a distal end of a first protruding plate provided in a protruding state to the first member, the second pivoting mount that is linked with the first pivoting mount so as to be able to undergo relative rotation via the shaft part is provided to a distal end of a second protruding plate provided in a protruding state to the second member, and a section disposed towards the base end of at least one of the first protruding plate and the second protruding plate is provided so as to be curved or arced, and is provided so that at least one of the first pivoting mount and the second pivoting mount moves away from the other.

11. The hinge device according to claim 5, wherein the first pivoting mount is provided to a distal end of a first protruding plate provided in a protruding state to the first member, the second pivoting mount that is linked with the first pivoting mount so as to be able to undergo relative rotation via the shaft part is provided to a distal end of a second protruding plate provided in a protruding state to the second member, and a section disposed towards the base end of at least one of the first protruding plate and the second protruding plate is provided so as to be curved or arced, and is provided so that at least one of the first pivoting mount and the second pivoting mount moves away from the other.

12. The hinge device according to claim 6, wherein the first pivoting mount is provided to a distal end of a first protruding plate provided in a protruding state to the first member, the second pivoting mount that is linked with the first pivoting mount so as to be able to undergo relative rotation via the shaft part is provided to a distal end of a second protruding plate provided in a protruding state to the second member, and a section disposed towards the base end of at least one of the first protruding plate and the second protruding plate is provided so as to be curved or arced, and is provided so that at least one of the first pivoting mount and the second pivoting mount moves away from the other.

13. The hinge device according to claim 1, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and the cam engaging part or the cam part is provided to the surface of the first pivoting mount or the second pivoting mount that is on the opposite side from the surface that faces the second pivoting mount or the first pivoting mount.

14. The hinge device according to claim 2, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or the second pivoting mount that is on the opposite side from the surface that faces the second pivoting mount or the first pivoting mount.

15. The hinge device according to claim 3, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or the second pivoting mount that is on the opposite side from the surface that faces the second pivoting mount or the first pivoting mount.

16. The hinge device according to claim 4, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or the second pivoting mount that is on the opposite side from the surface that faces the second pivoting mount or the first pivoting mount.

17. The hinge device according to claim 5, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or the second pivoting mount that is on the opposite side from the surface that faces the second pivoting mount or the first pivoting mount.

18. The hinge device according to claim 6, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or the second pivoting mount that is on the opposite side from the surface that faces the second pivoting mount or first pivoting mount.

19. The hinge device according to claim 7, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or the second pivoting mount that is on the opposite side from the surface that faces the second pivoting mount or the first pivoting mount.

20. The hinge device according to claim 8, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or the second pivoting mount that is on the opposite side from the surface that faces the second pivoting mount or the first pivoting mount.

21. The hinge device according to claim 9, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or second pivoting mount that is on the opposite side from the surface that faces the second pivoting mount or the first pivoting mount.

22. The hinge device according to claim 10, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or the second pivoting mount that is on the opposite side from the surface that faces the second pivoting mount or the first pivoting mount.

23. The hinge device according to claim 11, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or the second pivoting mount that is on the opposite side from the surface that faces the second pivoting mount or the first pivoting mount.

24. The hinge device according to claim 12, wherein a cam part that rotates together with the second pivoting mount or the first pivoting mount, and a cam engaging part that rotates together with the first pivoting mount or the second pivoting mount are provided while allowed to rotate relative to each other about the shaft part to produce a structure such that when the relatively rotating cam part and cam engaging part come into a concavoconvex engagement or a transient concavoconvex engagement, over-rotation of the first pivoting mount and the second pivoting mount is blocked by pressing and locking of the protrusion and the stop piece, whereby the rotational position of the cam part and the cam engaging part is maintained;
an engagement urging element for urging at least one of the cam part and the cam engaging part in the engagement direction is provided to produce a structure in which a concavoconvex engagement or a transient concavoconvex engagement of the cam part and the cam engaging part is maintained by the engagement and urging of the engagement urging element, and the cam part and the cam engaging part can be released from the concavoconvex engagement and rotated relative to each other against the engagement and urging; and
the cam engaging part or the cam part is provided to the surface of the first pivoting mount or the second pivoting mount that is on the opposite side from the surface that faces the second pivoting mount or the first pivoting mount.

25. An electronic device that uses a hinge device wherein a main body having a display part or an operating part on a top surface is used as a first member or a second member, a superimposed part having a display part or an operating part on a downward surface thereof is used as the second member or the first member, and the ends of the main body and the superimposed part are pivoted and linked together by the hinge device according to claim 1.

26. A hinge device for rotatably linking a first member and a second member, the hinge device comprising a first pivoting mount provided to the first member, and a second pivoting mount provided to the second member superimposed and linked with the first pivoting mount so that relative rotation is possible via a shaft part to produce a structure such that a stop piece for pressing against and locking onto a protrusion provided on the superimposed inner surface of one of the first pivoting mount and the second pivoting mount is provided to the outer circumferential edge part of the other pivoting mount to block over-rotation at a designated relative rotational position between the first pivoting mount and the second pivoting mount;
and at least one of the first pivoting mount and the second pivoting mount is provided so as to be able to slide or incline with respect to the shaft part in a manner such that one mount moves away from the other against the urging of the urging element, and the protrusion and the stop piece are shaped so that when rotational force is applied in the over-rotation direction after the over-rotation has been blocked by the protrusion pressing against and locking onto the stop piece, at least one of the first pivoting mount and the second pivoting mount moves in a direction away from the other, the protrusion is carried over and disengaged from, or is carried past and disengaged from, the stop piece in conjunction with the movement, and the over-rotation blocking condition between the first pivoting mount and the second pivoting mount is released, a tapered surface that is inclined in the direction in which the protrusion is released is formed on the stop piece.
